(19) United States
(12) Patent Application Publication
(10) Pub. No.: US 2019/0334196 A1
(43) Pub. Date: Oct. 31, 2019

(54) SIC-MOF ELECTROLYTE

(71) Applicant: Robert Bosch GmbH, Stuttgart (DE)

(72) Inventors: Joerg Thielen, Stuttgart (DE); Olga Heckel, Sindelfingen (DE)

(21) Appl. No.: 16/470,277

(22) PCT Filed: Nov. 20, 2017
(86) PCT No.: PCT/EP2017/079704

§ 371 Date: Jun. 17, 2019

(30) Foreign Application Priority Data
Dec. 16, 2016 (DE) 10 2016 225 273.9

(51) Int. Cl. H01M 10/056; C08L 57/06; H01M 10/0525; C07F 5/06

(52) U.S. Cl. CPC H01M 10/056; C08L 57/06; H01M 2/14; C07F 5/061; C08L 2203/20; H01M 10/0525

(57) ABSTRACT

The invention relates to an electrolyte (1, 1′), in particular a solid electrolyte, for an electrochemical cell and/or battery (100), in particular for a lithium cell and/or lithium battery. In order to enable fast charging of the cell and/or battery (100) and to extend the service life of the cell and/or battery (100), the electrolyte (1, 1′) comprises at least one metal-organic framework compound and at least one single-ion conductor. The invention further relates to a separator and/or to an electrode protection layer (10), to a cathode (11), to an anode, and to a cell and/or battery (100).

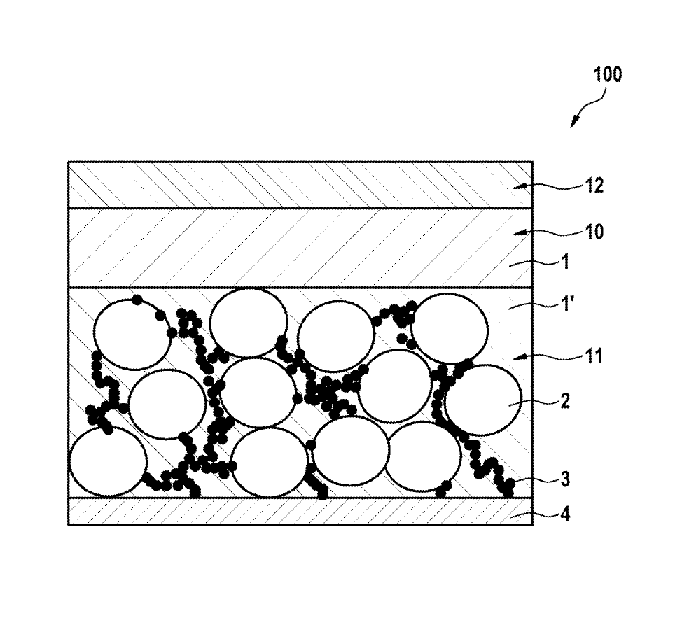

### BACKGROUND OF THE INVENTION

The present invention relates to an electrolyte for an electrochemical cell and/or battery, a separator, an electrode protective layer, a cathode, an anode and also an electrochemical cell and/or battery.

Battery cells, in particular lithium battery cells, comprise a cathode, an anode and a separator. The cathode and the anode are able to be electroconductively connected to one another via an external current circuit, in particular via current collectors for the output and input of electric current. In the cell, in particular between the cathode and the anode, the current circuit is closed via at least one electrolyte.

Use is mostly made of liquid electrolytes composed of a liquid solvent in which an electrolyte salt is dissolved.

Some battery cells have a polymer electrolyte based on a polymer and an electrolyte salt dissolved therein instead of a liquid electrolyte. To increase the conductivity, an additive, for example in the form of a liquid solvent, can be mixed into polymer electrolytes, as a result of which a polymer gel electrolyte can be formed.

Anodes composed of metallic lithium can, particularly when liquid electrolytes or polymer gel electrolytes and/or insufficiently mechanically stable polymer electrolytes are used, tend to formation of dendrites.

The document CN 103474696 relates to an organic-inorganic hybrid polymeric solid electrolyte material.

The document CN 104701542 relates to a composite cathode material for a solid-state lithium-sulfur battery.

### SUMMARY OF THE INVENTION

The present invention provides an electrolyte, in particular a solid electrolyte, for an electrochemical cell and/or battery, for example secondary battery, in particular for a lithium cell and/or lithium battery.

The electrolyte comprises, in particular, at least one metal-organic framework and at least one, in particular polymeric and/or inorganic, in particular glass-like and/or ceramic, single ion conductor.

As will be explained later, the invention further provides a separator and/or a protective layer, a cathode, an anode and an electrochemical cell and/or battery, in particular a lithium cell and/or lithium battery, which comprises at least one metal-organic framework and at least one, in particular polymeric and/or inorganic, for example glass-like and/or ceramic, single ion conductor or an electrolyte of this type.

A metal-organic framework (MOF) can be, in particular, a crystalline, in particular porous, material, in particular an inorganic-organic hybrid material, which comprises metal ions and organic molecules which form nodes and connecting elements, known as linkers, between nodes, from which a one-dimensional, two-dimensional or three-dimensional framework is built up. Here, metal ions, in particular single metal ions, for example transition metal ions and/or metal ions of the second, third and/or fourth main group, in particular of the Periodic Table, and/or metal ion clusters, for example clusters of transition metal ions and/or metal ions of the second, third and/or fourth main group, can serve as nodes and organic molecules can serve as connecting elements, or else organic molecules can serve as nodes and, in particular single, metal ions, for example transition metal ions and/or metal ions of the second, third and/or fourth main group, and/or metal ion clusters, for example clusters of transition metal ions and/or metal ions of the second, third and/or fourth main group, can serve as connecting elements. In particular, the nodes and connecting elements can build up a two-dimensional or three-dimensional, in particular three-dimensional, framework. Metal-organic frameworks can be, in particular, porous, for example microporous and/or mesoporous.

A single ion conductor can be, in particular, an in particular solid, for example organic, for example polymeric, and/or inorganic, for example glass-like and/or ceramic, material in which only one type of ion, in particular the electrochemically active species of the cell, for example cationic ions (cations), for example alkali metal ions, for example—as in the case of a lithium cell—lithium ions (Li), is or are mobile and/or in which the other type of ion, in particular the counterion(s) thereof, for example anionic ions (anions), is/are not mobile, for example covalently bound and/or incorporated in a salt lattice.

As a result of the electrolyte comprising a combination of at least one metal-organic framework and at least one single ion conductor, the electrolyte can advantageously have a high ionic conductivity and a high transference number, for example a lithium transference number, in particular of >0.5 or >0.6 or >0.7 or >0.8, possibly close to 1. Thus, a significantly higher transference number can be achieved by a combination of at least one metal-organic framework and at least one single ion conductor than in the case of liquid electrolytes which usually have only a transference number of <0.4 and compared to conventional polymer electrolytes, for example electrolytes based on polyethylene oxide/salt mixtures, for example PEO/LiTFSI, which usually have only a transference number of about 0.3. As a result of the at least one single ion conductor, the ions to be conducted, in particular lithium ions, in particular as single mobile type of ions, can advantageously be provided, and the mobility thereof and thus the ion conductivity of the electrolyte can be increased considerably by ion defects in the metal-organic framework, in particular without the high transference number being lost due to the presence of a further mobile type of ion, for example mobile electrolyte salt anions.

This advantageously makes it possible to minimize and possibly even eliminate, at a constant high current loading, concentration gradients or concentration polarizations which can form at high current densities applied over extended periods of time in the case of conventional electrolytes having a transference number of <0.4 or even ≤0.3 and can lead to high overvoltages which limit the achievable current density.

Thus, high current densities can advantageously be maintained even over long times or large A-SOC ranges, in particular for a constant high current loading, for example of 3 C or above, in the charging and discharging direction and also a high maximum current capability can be achieved, in particular rapid charging of the cell can also be realized.

In addition, damage to the cell and/or secondary reactions, for example in a cathode, associated with overvoltages can advantageously be reduced and a long life of the cell, in particular also at high maximum current, can be achieved in this way.

Furthermore, single ion conductors and metal-organic frameworks can advantageously have a higher electrochemical stability than the polymer electrolytes customarily used, for example based on polyethylene oxide/salt mixtures, which have an electrochemical stability significantly below 4 V relative to lithium metal. This can be particularly relevant for use as electrolyte in the cathode (catholyte), in particular when the total capacity of the cathode active material is to be utilized, since many known intercalation compounds which can be used as cathode active material, for example nickel-cobalt-aluminum oxide (NCA), nickel-cobalt-manganese oxide (NCM), high-energy nickel-cobalt-manganese oxide (HE-NCM), lithium-manganese oxide (LMO) and/or high-voltage spinels (HV-LMO), which owing to their properties are predestined for cells having high energy densities or, compared to other systems, for example systems based on lithium-iron phosphates or sulfur composites, have significantly higher energy densities or have a comparatively high average charging/discharging voltage which is more advantageous for the battery management system, have potentials of >4 V in the delithiated state.

Furthermore, single ion conductors and metal-organic frameworks, in particular in combination, can have a higher mechanical and thermal stability compared to the polymer electrolytes customarily used, for example based on polyethylene oxide/salt mixtures.

Electrochemical and thermal stability and in particular mechanical stability is particularly advantageous for use of the electrolyte in a separator and/or an electrode protective layer, for example in order to reduce, for example when using a lithium metal anode, in particular composed of metallic lithium, lithium dendrite formation, which can in turn have an advantageous effect on the life of a cell equipped therewith, for example having a lithium metal anode.

Overall, cells and/or batteries, in particular lithium cells and/or lithium batteries, in particular based on a solid electrolyte, which can be charged quickly and have a long life and can, in particular, be used in electric vehicles but also, for example, in consumer applications such as mobile computers, tablets and/or smartphones, can therefore advantageously be provided by means of the electrolyte.

The at least one single ion conductor can, in particular, comprise or be at least one single-ion-conducting polyelectrolyte and/or at least one inorganic, in particular glass-like and/or ceramic, single ion conductor, for example at least one lithium argyrodite and/or at least one sulfidic glass.

A single-ion-conducting polyelectrolyte can be, in particular, an in particular solid polymer in which only one type of ion, in particular the electrochemically active species of the cell, for example cationic ions (cations), for example alkali metal ions, for example—as in the case of a lithium cell—lithium ions (Li⁺), is/are mobile and/or in which the other type of ion, in particular the counterion(s) thereof, for example anionic ions (anions) is/are not mobile, in particular covalently bound.

Lithium argyrodites can be, in particular, compounds which are derived from the mineral argyrodite of the general chemical formula: Ag₈GeS₆, where silver (Ag) is replaced by lithium (Li) and, in particular, germanium (Ge) and/or sulfur (S) can be replaced by other, for example cheaper, elements, for example of main groups III., IV., IV., VI. and/or VII.

In one embodiment, the electrolyte comprises at least one metal-organic framework and at least one single-ion-conducting polyelectrolyte. Such an electrolyte can advantageously be used both as separator and/or electrode-protective layer and also as electrolyte in the cathode (catholyte) and/or anode (anolyte).

In another embodiment, the electrolyte comprises at least one metal-organic framework and at least one inorganic, in particular glass-like and/or ceramic, single ion conductor, for example at least one sulfidic glass, for example at least one argyrodite. Such an electrolyte can advantageously be used both as separator and/or electrode-protective layer and also as electrolyte in the cathode (catholyte) and/or anode (anolyte).

In a further embodiment, the electrolyte comprises at least one metal-organic framework, at least one single-ion-conducting polyelectrolyte and at least one inorganic, in particular glass-like and/or ceramic, single ion conductor, for example at least one sulfidic glass, for example at least one argyrodite. Such an electrolyte can advantageously be used both as separator and/or electrode-protective layer and also as electrolyte in the cathode (catholyte) and/or anode (anolyte).

In particular, the at least one electrolyte can be made up of at least one metal-organic framework and at least one single-ion-conducting polyelectrolyte or of at least one metal-organic framework and at least one inorganic single ion conductor or of at least one metal-organic framework and at least one single-ion-conducting polyelectrolyte and at least one inorganic single ion conductor and/or, for example for use of the electrolyte in the form of a separator and/or an electrode-protective layer, be, for example, free of, for example conventional, electrolyte salts, in particular lithium electrolyte salts, having mobile cations and mobile anions, for example free of lithium bis(trifluoromethanesulfonyl)imide (LiTFSI), and/or, for example, free of, for example conventional, ion-conductive, for example lithium ion-conductive, polymer/salt mixtures, in particular polymer/lithium electrolyte salt mixtures. This can be advantageous for, in particular, use of the electrolyte in the form of a separator and/or an electrode-protective layer. This is because single-ion-conducting polyelectrolytes can advantageously have, in particular in contrast to, for example conventional, ion-conductive, in particular lithium ion-conductive, polymers such as polyethylene oxide, altered solubility behavior and as a result, particularly with targeted selection of cathode additive, virtually no swellability or swellability to a significantly lesser degree, so that a separator configured in this way and/or an electrode-protective layer configured in this way can additionally take on the function of a barrier for optional liquid components or additives of the catholyte and/or anolyte and thus remain mechanically stable and therefore, particularly in the case of a metallic lithium anode, can significantly reduce dendrite growth and have a positive influence on the life of the cell. Thus, conventional electrolyte salts having mobile cations and mobile anions and/or liquid components such as at least one liquid electrolyte and/or at least one ionic liquid and/or at least one gel-forming solvent can advantageously be used in the cathode and/or in the anode, for example the disadvantages associated therewith, for example a reduction in the transference number and/or the mechanical stability, can be reduced and, in particular, advantages associated with the use thereof, for example an increase in the ion conductivity, can be utilized. Constant current charging of greater than 1 C up to 3 C can advantageously be realized even at a transference number of <0.7 of the catholyte and/or anolyte, for example which can be reduced by optional addition of an in particular conventional electrolyte salt, by means of such a separator or such a protective layer. As a result, high loadings of the cathode and/or anode with active material, for example ≥2 mAh/cm² or ≥3 C, can also be achieved.

Such electrolytes can, for example, be used as separators and/or electrode coatings and/or catholyte and/or anolyte, also particularly advantageously together with cathode active materials based on sulfur, for example sulfur-polymer and/or -carbon composites, for example polyacrylonitrile-sulfur composites such as SPAN, since these can have a lower polysulfide solubility compared to ether-based polymer/salt mixtures such as polyethylene oxide/lithium electrolyte salt mixtures, and can thus particularly successfully counter a shuttle mechanism. For example, the electrolyte can therefore, when used as catholyte in combination with at least one cathode active material based on sulfur, comprise or be formed by at least one metal-organic framework and at least one single-ion-conducting polyelectrolyte and/or at least one inorganic single ion conductor.

The at least one metal-organic framework can, for example, have a two-dimensional or, possibly to a lesser degree, three-dimensional network. Directed conduction can advantageously be achieved by means of a two-dimensional network.

In a further embodiment, the at least one metal-organic framework comprises aluminum and/or zinc or the at least one metal-organic framework is based on aluminum and/or zinc.

For example, the at least one metal-organic framework can be a (poly)carboxylate or be based on a (poly)carboxylate.

In a specific embodiment, the at least one metal-organic framework comprises or is an aluminum carboxylate, in particular an aluminum dicarboxylate, tricarboxylate or polycarboxylate.

Suitable aluminum-based metal-organic frameworks are described, for example, in J. Mater. Chem. A, 2014, 2, 9948-9954, RSC Adv., 2014, 4, 42278-42284 and J. Mater. Chem. A, 2015, 3, 10760-10766.

For example, the at least one metal-organic framework can comprise or be an aluminum 1,4-benzenedicarboxylate, for example MIL-53(Al), and/or aluminum 1,3,5-tribenzenecarboxylate.

In a further embodiment, the electrolyte additionally comprises at least one ion-conductive, in particular lithium ion-conductive, polymer. The ion mobility and thus the ion conductivity can advantageously be increased further in this way.

An ion-conductive, for example lithium ion-conductive, polymer can be, in particular, a polymer which itself can be free of the ions to be conducted, for example lithium ions, but is suitable for coordinating and/or solvating the ions to be conducted, for example lithium ions, and/or counterions of the ions to be conducted, for example lithium electrolyte salt anions, and becomes ion-conducting, for example lithium ion-conducting, for example with addition of the ions to be conducted, for example lithium ions, in particular in the form of the single ion conductor.

For example, the at least one ion-conductive, in particular lithium ion-conductive, polymer can comprise or be polyethylene oxide.

In a further embodiment, the at least one single-ion-conducting polyelectrolyte comprises at least one unit of the general chemical formula:

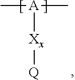

for example

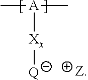

Here, -[A]- is, in particular, a unit forming a polymer backbone. X is in particular a spacer, in particular a spacer bound, for example covalently, to the polymer backbone-forming unit -[A]- or the polymer backbone. x is, in particular, the number, in particular the presence or absence, of the spacer X. x can be, in particular, 1 or 0, for example 1. In the case of x=1, one spacer X can, in particular, be present. In the case of x=0, no spacer can, in particular, be present. Q is in particular a group which is bound, in particular covalently, to the spacer X (in the case of x=1) or to the polymer backbone -[A]- (in the case of x=0). In particular, the group Q can be bound by the spacer X to the polymer backbone-forming unit -[A]-.

Q is in particular a negatively charged group Q⁻ and a counterion Z⁺.

In the case of x=1 (presence of the spacer), the negatively charged group Q⁻ can, in particular, be bound to the spacer X. In the case of x=0 (absence of the spacer), the negatively charged group Q⁻ can, in particular, be bound directly to the polymer backbone -[A]-.

The counterion Z⁺ can, in particular, be a cation, for example an electrochemically active cation, in particular a metal ion, for example an alkali metal ion, for example lithium ion and/or sodium ion. In particular, Z⁺ can be a lithium ion (Li⁺).

The negatively charged group Q⁻ can, for example, be a group based on an electrolyte salt anion, in particular a lithium electrolyte salt anion, for example a borate anion and/or a sulfonylimide anion, for example a trifluoromethanesulfonylimide anion (TFSI⁻: F₃C—SO₂—(N)—SO₂—) and/or perfluoroethanesulfonylimide anion (PFSI⁻: F₅C₂—SO₂—(N)—SO₂—) and/or fluorosulfonylimide anion (FSI: F—SO₂—(N)—SO₂—), and/or a group based on an anion of an ionic liquid, for example a pyrazolide anion or an imidazolium anion, and/or a sulfonate anion, for example a (simple) sulfonate anion (—SO₃—) or a trifluoromethanesulfonate anion (triflate, ⁻SO₃CF₂), and/or a sulfate anion and/or a carboxylate anion and/or a phosphate anion, and/or an amide anion, in particular a secondary amide anion, and/or a carboxamide anion, in particular a secondary carboxamide anion.

In a further embodiment, the negatively charged group Q⁻ is a borate anion and/or a sulfonylimide anion, in particular a perfluoroalkylsulfonylimide anion, for example a trifluoromethanesulfonylimide anion and/or a perfluoroethanesulfonylimide anion and/or fluorosulfonylimide anion, in particular a trifluoromethanesulfonylimide anion, and/or a sulfonate anion, for example a (simple) sulfonate anion (—SO₃—) or a trifluoromethanesulfonate anion (⁻SO₃CF₂—). A comparatively weak coordination of cations, in particular lithium ions, which thus increases the ion mobility and ion conductivity, can advantageously be achieved by means of borate anions, sulfonylimide anions and sulfonate anions.

The spacer X can, for example, comprise at least one in particular substituted or unsubstituted, saturated or unsaturated, linear or branched, alkylene group and/or at least one in particular substituted or unsubstituted, saturated or unsaturated, linear or branched, alkylene oxide group and/or at least one in particular substituted or unsubstituted phenylene oxide group and/or at least one in particular substituted or unsubstituted phenylene group and/or at least one in particular substituted or unsubstituted benzylene group and/or at least one carbonyl group and/or at least one cyclic carbonate group and/or at least one lactone group and/or at least one cyclic carbamate group and/or at least one acyclic carbonate group and/or at least one acyclic carboxylic acid ester group and/or at least one acyclic carbamate group and/or at least one (ether) oxygen and/or at least one further negatively charged group.

-[A]- can be, for example, a unit forming a polymer backbone or oligomer backbone, which comprises (at least) an alkylene oxide unit, in particular ethylene oxide unit and/or propylene oxide unit, and/or a siloxane unit and/or a phosphazene unit and/or an acrylic unit, for example a methylmethacrylate unit and/or a methacrylate unit, and/or a phenylene unit, for example a para-phenylene unit, and/or a phenylene oxide unit and/or a benzylene unit and/or an alkylene unit.

The polymer backbone-forming unit -[A]- can be either monofunctionalized or polyfunctionalized, for example bifunctionalized, trifunctionalized or tetrafunctionalized, with the negatively charged group Q⁻ optionally bound via the spacer X. Here, a polyfunctionalized polymer backbone-forming unit -[A]- can in particular be a polymer backbone-forming unit -[A]- which is functionalized by at least two negatively charged groups Q, in particular with in each case a negatively charged group Q⁻ being bound, optionally via a spacer X, to the polymer backbone-forming unit -[A]-.

The at least one single-ion-conducting polyelectrolyte can, for example, comprise or be a homopolymer and/or a copolymer and/or a block copolymer which comprises at least one unit of the general chemical formula:

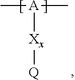

for example

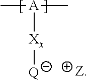

In the case of a copolymer or block copolymer, at least one further unit, for example a styrene unit and/or an in particular unsubstituted alkylene oxide unit, for example an ethylene oxide unit, can optionally also be present. The mechanical stability or the ion conductivity of the at least one single-ion-conducting polyelectrolyte may be able to be increased further in this way.

For example, the at least one single-ion-conducting polyelectrolyte can have at least one borate anion and/or perfluoroalkylsulfonylimide anion and/or a sulfonate anion and/or comprise or be an Li-Nafion and/or a poly-4-styrenesulfonyl-TFSI homopolymer or block copolymer, for example with polyethylene oxide, and/or a polyacrylic-TFSI-based polymer.

Suitable single-ion-conducting polyelectrolytes, in particular based on the above general chemical formulae, are described, for example, in the document WO 2015/185337 A2.

In a further embodiment, the at least one inorganic, in particular glass-like and/or ceramic, single ion conductor comprises at least one lithium argyrodite and/or at least one sulfidic glass. In particular, the at least one inorganic, in particular glass-like and/or ceramic, single ion conductor can be at least one lithium argyrodite and/or at least one sulfidic glass.

These inorganic single ion conductors have been found to be particularly advantageous because they can have a high ion conductivity and low contact transition resistances at the grain boundaries within the material and also to further components, for example the metal-organic framework and/or the cathode active material and/or the anode active material. In addition, these single ion conductors can be ductile, for which reason they can be used particularly advantageously in the case of, in particular, porous materials such as metal-organic frameworks and/or active materials which can have a rough surface.

Examples of lithium argyrodites are:

Compounds of the general chemical formula:

Li₇PCh₆

where Ch is sulfur (S) and/or oxygen (O) and/or selenium (Se), for example sulfur (S) and/or selenium (Se), in particular sulfur (S),

Compounds of the general chemical formula:

Li₆PCh₅X

where Ch is sulfur (S) and/or oxygen (O) and/or selenium (Se), for example sulfur (S) and/or oxygen (O), in particular sulfur (S), and X is chlorine (Cl) and/or bromine (Br) and/or iodine (I) and/or fluorine (F), for example X is chlorine (Cl) and/or bromine (Br) and/or iodine (I),

Compounds of the general chemical formula:

Li_{7-δ}BCh_{6-δ}X_{δ}

where Ch is sulfur (S) and/or oxygen (O) and/or selenium (Se), for example sulfur (S) and/or selenium (Se), in particular sulfur (S), B is phosphorus (P) and/or arsenic (As), X is chlorine (Cl) and/or bromine (Br) and/or iodine (I) and/or fluorine (F), for example X is chlorine (Cl) and/or bromine (Br) and/or iodine (I), and 0≤δ≤1.

For example, the at least one inorganic single ion conductor can comprise at least one lithium argyrodite of the chemical formula: Li₇PS₆, Li₇PSe₆, Li₆PS₅C₁, Li₆PS₅Br, Li₆PS₅I, Li_{7-δ}PS_{6-δ}Cl_{δ}, Li_{7-δ}PS_{6-δ}Br_{δ}, Li_{7-δ}PS_{6-δ}I_{δ}, Li_{7-δ}PSe_{6-δ}Cl_{δ}, Li_{7-δ}PSe_{6-δ}Br₆, Li_{7-δ}PSe_{6-δ}I₆, Li_{7-δ}AsS_{6-δ}Br₆, Li_{7-δ}AsS_{6-δ}I_{δ}, Li₆AsS₅I, Li₆AsSe₅I, Li₆PO₅Cl, Li₆PO₅Br and/or Li₆PO₅I. Lithium argyrodites are described, for example, in the documents: Angew. Chem. Int. Ed., 2008, 47, 755-758; Z. Anorg. Allg. Chem., 2010, 636, 1920-1924; Chem. Eur. J., 2010, 16, 2198-2206; Chem. Eur. J., 2010, 16, 5138-5147; Chem. Eur. J., 2010, 16, 8347-8354; Solid State Ionics, 2012, 221, 1-5; Z. Anorg. Allg. Chem., 2011, 637, 1287-1294; and Solid State Ionics, 2013, 243, 45-48.

In particular, the lithium argyrodite can be a sulfidic lithium argyrodite, for example one in which Ch is sulfur (S).

Lithium argyrodites can be prepared, in particular, by means of a mechanochemical reaction process, for example a process in which starting materials such as lithium halides, for example LiCl, LiBr and/or Lil, and/or lithium chalcogenides, for example Li₂S and/or Li₂Se and/or Li₂O, and/or chalcogenides of main group V., for example P₂S₅, P₂Se₅, Li₃PO₄, in particular in stoichiometric amounts, are milled together with one another. This can be carried out, for example, in a ball mill, in particular a high-energy ball mill, for example with a speed of rotation of 600 rpm. In particular, milling can be carried out under a protective gas atmosphere.

In one embodiment, the at least one inorganic single ion conductor comprises or is at least one sulfidic glass of the chemical formula: Li₁₀GeP₂S₁₂, Li₂S—(GeS₂)—P₂S₅ and/or Li₂S—P₂S₅. For example, the at least one inorganic single ion conductor can comprise a germanium-containing, sulfidic glass, for example Li₁₀GeP₂S₁₂ and/or Li₂S—(GeS₂)—P₂S₅, in particular Li₁₀GeP₂S₁₂. Sulfidic glasses can advantageously have a high lithium ion conductivity and chemical stability.

In a further embodiment, the at least one inorganic single ion conductor comprises or is a lithium argyrodite(s). Lithium argyrodites advantageously display particularly low contact transition resistances at the grain boundaries within the material and also to further components, for example the porous active material particles. Particularly good ion conduction can advantageously be achieved at and within the grain boundaries in this way.

Lithium argyrodites can advantageously have a low transition resistance between grains even without a sintering process. The production of the electrode or the cell can advantageously be simplified in this way.

In a further embodiment, the electrolyte further comprises at least one liquid electrolyte, in particular composed of at least one electrolyte solvent, for example ethylene carbonate (EC) and/or dimethyl carbonate (DMC) and/or diethyl carbonate (DEC), and at least one electrolyte salt, in particular lithium electrolyte salt, for example lithium bis(trifluoromethanesulfonyl)imide (LiTFSI), and/or at least one ionic liquid and/or at least one gel-forming solvent. The ionic conductivity can advantageously be increased, possibly significantly, for example up to more than one order of magnitude, in this way.

The at least one liquid electrolyte, the at least one ionic liquid or the at least one gel-forming solvent can optionally penetrate into pores of the at least one metal-organic framework and/or into pores of a cathode active material and/or anode active material and fill these and in this way increase ion diffusion and thus ionic conductivity.

The ion diffusion and the ionic conductivity can advantageously be increased, in particular with maintenance of a high transference number, by means of the at least one ionic liquid.

When a separator and/or an electrode layer is used, which separator is made up of at least one metal-organic framework and at least one single-ion-conducting polyelectrolyte and/or at least one inorganic ion conductor and/or is, for example, free of, for example conventional, electrolyte salts, in particular lithium electrolyte salts, having mobile cations and mobile anions, for example free of lithium bis(trifluoromethanesulfonyl)imide (LiTFSI), and/or, for example, free of, for example conventional, ion-conductive, in particular lithium ion-conductive, polymer/salt mixtures, in particular polymer/lithium electrolyte salt mixtures, the catholyte and/or anolyte can, advantageously also with maintenance of a high transference number, comprise at least one liquid electrolyte, in particular composed of at least one electrolyte solvent and at least one electrolyte salt, in particular lithium electrolyte salt, and/or at least one ionic liquid and/or at least one gel-forming solvent.

For example, the at least one lithium electrolyte salt, in particular of the catholyte and/or anolyte, can comprise or be lithium bis(trifluoromethanesulfonyl)imide (LiTFSI) and/or lithium hexafluorophosphate (LiPF₆) and/or lithium bisoxalatoborate (LiBOB) and/or trifluoromethanesulfonate (Li triflate) and/or lithium perchlorate (LiClO₄) and/or lithium difluorooxalatoborate (LiDFOB) and/or lithium tetrafluoroborate (LiBF₄) and/or lithium bromide (LiBr) and/or lithium iodide (LiI) and/or lithium chloride (LiCl).

In a further embodiment, the electrolyte is a catholyte and/or an anolyte. A catholyte can be, in particular, an electrolyte of a cathode and an anolyte can be, in particular, an electrolyte of an anode.

The electrolyte can comprise, in particular, a mixture, for example a dispersion/suspension, of particles of the at least one metal-organic framework and the at least one single ion conductor, in particular the at least one single-ion-conducting polyelectrolyte and/or the at least one inorganic single ion conductor, and optionally at least one ion-conductive, in particular lithium ion-conductive, polymer and/or at least one liquid electrolyte and/or at least one ionic liquid and/or at least one gel-forming solvent, or be formed thereby.

For example, the electrolyte can comprise from ≥5% by weight to ≤20% by weight of the at least one metal-organic framework.

As regards further technical features and advantages of the electrolyte according to the invention, explicit reference is made here to the explanations given in connection with the separator of the invention and/or the electrode-protective layer of the invention, the cathode of the invention, the anode of the invention and the cell and/or battery of the invention and also to the FIGURE and the description of the FIGURE.

The invention further provides a separator and/or electrode-protective layer for an electrochemical cell and/or battery, for example secondary battery, in particular for a lithium cell and/or battery, which comprises at least one metal-organic framework and at least one, in particular polymeric and/or inorganic, for example glass-like and/or ceramic, single ion conductor or an electrolyte according to the invention or is formed thereby.

In particular, the separator and/or the electrode-protective layer can comprise at least one metal-organic framework and at least one single-ion-conducting polyelectrolyte and/or at least one inorganic, in particular glass-like and/or ceramic, single ion conductor, for example at least one sulfidic glass and/or at least one lithium argyrodite.

In one embodiment, the electrolyte comprises from ≥5% by weight to ≤20% by weight of the at least one metal-organic framework.

The separator or the electrode-protective layer can have been or be produced by hot pressing of a dispersion/suspension of the at least one metal-organic framework and the at least one single-ion-conducting polyelectrolyte, for example to give an in particular thin layer, for example from ≥10 μm to ≤50 μm, for example about 20 μm.

In particular, the separator or the electrode-protective layer can have been or be produced by direct application, for example by means of a casting process, for example slurry process, to an electrode. The separator or the electrode-protective layer can advantageously be produced industrially in this way.

The separator can, in particular, comprise a mixture, for example a dispersion/suspension, of particles of the at least one metal-organic framework and the at least one single ion conductor, in particular at least one single-ion-conducting polyelectrolyte and/or at least one inorganic single ion conductor, or be formed thereby.

As regards further technical features and advantages of the separator of the invention and/or the electrode-protective layer of the invention, reference is hereby explicitly made to the explanations in connection with the electrolyte of the invention, the cathode of the invention, the anode of the invention and the cell and/or battery of the invention and also to the FIGURE and the description of the FIGURE.

In addition, the invention provides a cathode for an electrochemical cell and/or battery, for example secondary battery, in particular for a lithium cell and/or lithium battery, which comprises at least one cathode active material, at least one metal-organic framework and at least one, in particular polymeric and/or inorganic, for example glass-like and/or ceramic, single ion conductor or at least one cathode active material and an electrolyte according to the invention.

The at least one cathode active material can comprise, for example, at least one intercalation and/or insertion material, in particular a lithium intercalation and/or insertion material, i.e. a material which can incorporate, in particular intercalate and/or insert, ions, in particular lithium, for example on a metal oxide basis, and/or at least one conversion material, in particular a lithium conversion material, i.e. a material which can undergo a conversion reaction, in particular with lithium, for example on a sulfur basis, or be formed thereby.

In one embodiment, the at least one cathode active material comprises at least one intercalation and/or insertion material, in particular lithium intercalation and/or insertion material, for example nickel-cobalt-aluminum oxide (NCA) and/or nickel-cobalt-manganese oxide (NCM) and/or high-energy nickel-cobalt-manganese oxide (HE-NCM) and/or lithium-manganese oxide (LMO) and/or a high-voltage spinel (HV-LMO), in particular nickel-cobalt-aluminum oxide (NCA), or is formed thereby.

In a further embodiment, the at least one cathode active material comprises at least one conversion material, in particular lithium conversion material, for example at least one sulfur-polymer and/or sulfur-carbon composite, for example at least one polyacrylonitrile-sulfur composite, for example SPAN, or is formed thereby.

SPAN can be, in particular, a composite or polymer which is based on polyacrylonitrile (PAN), in particular cyclized polyacrylonitrile (cPAN), and has, in particular covalently, bound sulfur, and is, in particular, obtainable by thermal conversion and/or chemical reaction of polyacrylonitrile in the presence of sulfur. In particular, nitrile groups can react to form a polymer, in particular having a conjugated 7t system, in which the nitrile groups are converted into adjoined, nitrogen-containing rings, in particular six-membered rings, in particular with covalently bound sulfur. For example, SPAN can be produced by heating of polyacrylonitrile (PAN) with an excess of elemental sulfur, in particular at a temperature of ≥300° C., for example from about ≥300° C. to ≤600° C. Here, the sulfur can, in particular, cyclize the polyacrylonitrile (PAN) with formation of hydrogen sulfide (H₂S) and also, for example with formation of a covalent S—C bond, be bound in a finely dispersed manner in the cyclized matrix, for example with formation of a cyclized polyacrylonitrile structure having covalent sulfur chains. SPAN is described in Chem. Mater., 2011, 23, 5024 and J. Mater. Chem., 2012, 22, 23240, J. Elektrochem. Soc., 2013, 160 (8) A1170, and in the document WO 2013/182360 A1.

In particular, the cathode can comprise at least one cathode active material, at least one metal-organic framework, at least one single-ion-conducting polyelectrolyte and at least one liquid electrolyte and/or at least one ionic liquid. Here, the at least one cathode active material can, for example, be present in particulate form, for example in the form of spherical, elongated, floc-like and/or fiber-like particles, and, for example, be surrounded by the electrolyte according to the invention.

For example, if the at least one cathode active material does not percolate sufficiently and/or itself does not have a sufficiently high electrical conductivity, the cathode can, for example, additionally comprise at least one electrically conductive addition.

Furthermore, the cathode can therefore comprise, for example, at least one electrically conductive addition, for example at least one conductive additive, in particular for improving the electrical conductivity, for example carbon black and/or graphite.

The cathode can, in particular, comprise a mixture, for example a dispersion/suspension, of particles of the at least one cathode active material, particles of the at least one metal-organic framework and the at least one single ion conductor, in particular the at least one single-ion-conducting polyelectrolyte and/or the at least one inorganic single ion conductor, and optionally particles of the at least one conductive addition and/or at least one ion-conductive, in particular lithium ion-conductive, polymer and/or at least one liquid electrolyte and/or at least one ionic liquid and/or at least one gel-forming solvent or be formed thereby.

As regards further technical features and advantages of the cathode of the invention, reference is hereby explicitly made to the explanations in connection with the electrolyte of the invention, the separator of the invention and/or the electrode-protective layer of the invention, the anode of the invention and the cell and/or battery of the invention and also to the FIGURE and the description of the FIGURE.

The invention further provides an anode for an electrochemical cell and/or battery, for example secondary battery, in particular for a lithium cell and/or lithium battery, which comprises at least one anode active material, at least one metal-organic framework and at least one, in particular polymeric and/or inorganic, for example glass-like and/or ceramic, single ion conductor or at least one anode active material and an electrolyte according to the invention.

The at least one anode active material can, for example, comprise or be at least one intercalation material and/or insertion material, in particular lithium intercalation material and/or insertion material, for example graphite and/or amorphous carbon and/or a lithium titanate, and/or at least one alloying material, in particular lithium alloying material, for example silicon and/or tin. Here, the at least one anode active material can, for example, be present in particulate form, for example in the form of spherical, elongated, floc-like and/or fiber-like particles and, for example, be surrounded by the electrolyte according to the invention.

For example, if the at least one anode active material does not percolate sufficiently and/or itself does not have a sufficiently high electrical conductivity, the anode can, for example, additionally comprise at least one electrically conductive addition.

Furthermore, the anode can therefore comprise, for example, at least one electrically conductive addition, for example at least one conductive additive, in particular for improving the electrical conductivity, for example carbon black and/or graphite.

The anode can, in particular, comprise a mixture, for example a dispersion/suspension, of particles of the at least one anode active material, particles of the at least one metal-organic framework and the at least one single ion conductor, in particular the at least one single-ion-conducting polyelectrolyte and/or the at least one inorganic single ion conductor, and optionally particles of the at least one conductive addition and/or at least one ion-conductive, in particular lithium ion-conductive, polymer and/or at least one liquid electrolyte and/or at least one ionic liquid and/or at least one gel-forming solvent or be formed thereby.

As regards further technical features and advantages of the anode of the invention, reference is hereby explicitly made to the explanations in connection with the electrolyte of the invention, the separator of the invention and/or the electrode-protective layer of the invention, the cathode of the invention and the cell and/or battery of the invention and also to the FIGURE and the description of the FIGURE.

The invention further provides an electrochemical cell and/or battery, for example secondary battery, in particular a lithium cell and/or lithium battery, which comprises a cathode and an anode, wherein a separator and/or an electrode-protective layer is arranged between the cathode and the anode and the cell and/or battery comprises at least one electrolyte according to the invention.

The cathode can, in particular, comprise at least one cathode active material. The anode can, in particular, comprise at least one anode active material.

The cell and/or battery can comprise, in particular, a separator according to the invention and/or an electrode-protective layer according to the invention and/or a cathode according to the invention and/or an anode according to the invention. Here, the electrolytes according to the invention, in particular the at least one metal-organic framework and/or the at least one single ion conductor, for example the at least one single-ion-conducting polyelectrolyte and/or the at least one inorganic single ion conductor, and/or the composition thereof, the separator of the invention and/or the electrode-protective layer of the invention and/or the cathode of the invention and/or the anode of the invention can have been adapted and optimized, either in the same way or differently, in particular taking into account the respective requirements, for example in respect of the dissolution behavior, the voltage stability, the volume work, etc., in the respective field of use of the cell.

In one embodiment, the separator and/or the electrode-protective layer is a separator according to the invention and/or an electrode-protective layer according to the invention.

In a further, alternative or additional embodiment, the anode is a lithium metal anode or an anode according to the invention.

In a further, alternative or additional embodiment, the cathode is a cathode according to the invention.

In a further embodiment, especially in which the separator and/or the electrode-protective layer is/are a separator according to the invention and/or an electrode-protective layer according to the invention, the cathode comprises an electrolyte, in particular catholyte, which comprises at least one metal-organic framework and at least one polymer electrolyte composed of at least one ion-conductive polymer, for example polyethylene oxide (PEO), and at least one electrolyte salt, in particular lithium electrolyte salt, for example lithium bis(trifluoromethanesulfonyl)imide (LiTFSI), or is formed thereby. In this way, an increased ionic conductivity can be achieved, especially compared to a combination of at least one metal-organic framework and at least one single ion conductor. The combination of such a cathode with a separator according to the invention and/or with an electrode-protective layer according to the invention can advantageously counter a decrease in the transference number, for example to <0.5, and an increased ion conductivity and a high transference number can thus be achieved. The polymer electrolyte can, for example, be a polymer gel electrolyte and/or the cathode can additionally comprise at least one liquid electrolyte and/or at least one ionic liquid and/or at least one gel-forming solvent.

In particular, the cell and/or battery can have a separator according to the invention and/or an electrode-protective layer according to the invention and a cathode according to the invention and an anode according to the invention.

The at least one cathode active material can, for example, comprise at least one intercalation and/or insertion material, in particular a lithium intercalation and/or insertion material, i.e. a material which can incorporate, in particular intercalate and/or insert, ions, in particular lithium, for example on a metal oxide basis, and/or at least one conversion material, in particular a lithium conversion material, i.e. a material which can undergo a conversion reaction, in particular with lithium, for example on a sulfur basis, or be formed thereby.

In one embodiment, the at least one cathode active material comprises at least one intercalation and/or insertion material, in particular lithium intercalation and/or insertion material, for example nickel-cobalt-aluminum oxide (NCA) and/or nickel-cobalt-manganese oxide (NCM) and/or high-energy nickel-cobalt-manganese oxide (HE-NCM) and/or lithium-manganese oxide (LMO) and/or a high-voltage spinel (HV-LMO), in particular nickel-cobalt-aluminum oxide (NCA), or is formed thereby.

In a further embodiment, the at least one cathode active material comprises at least one conversion material, in particular lithium conversion material, for example at least one sulfur-polymer and/or sulfur-carbon composite, for example at least one polyacrylonitrile-sulfur composite, for example SPAN, or is formed thereby.

Furthermore, the cathode and/or the anode can, for example, comprise at least one electrically conductive addition, for example at least one conductive additive, in particular for improving the electrical conductivity, for example carbon black and/or graphite.

As regards further technical features and advantages of the cell and/or battery of the invention, reference is hereby made explicitly to the explanations in connection with the electrolyte of the invention, the separator of the invention and/or the electrode-protective layer of the invention, the cathode of the invention and the cell and/or battery of the invention and also to the FIGURE and the description of the FIGURE.

### BRIEF DESCRIPTION OF THE DRAWING

Further advantages and advantageous embodiments of the subject matter of the invention are illustrated by the drawing and explained in the following description. It should be noted that the drawing has only a descriptive character and is not intended to restrict the invention in any way.

The single drawing FIGURE shows a schematic cross section through an embodiment of a cell according to the invention.

### DETAILED DESCRIPTION

The drawing FIGURE shows an embodiment of a cell 100 according to the invention, in particular in the form of a lithium cell, which comprises at least one electrolyte, in particular solid electrolyte, which comprises at least one metal-organic framework and at least one single ion conductor, for example at least one single-ion-conducting polyelectrolyte and/or at least one inorganic single ion conductor. For example, the at least one metal-organic framework can be an aluminum carboxylate such as aluminum 1,4-benzenedicarboxylate and/or aluminum 1,3,5-tribenzenecarboxylate.

The drawing FIGURE shows that the cell 100 comprises a cathode 11 and an anode 12, with a separator or an electrode-protective layer 10 being arranged between the cathode 11 and the anode 12. In the embodiment depicted, the separator or the electrode-protective layer 10 performs not only the function of electronic insulation of cathode 11 and anode 12 but also the function of a protective layer, in particular for the anode 12, for example a lithium metal anode, which serves to prevent dendrite growth from the anode 12 to the cathode 11 and thus associated internal short circuits over the desired cycling life.

The drawing FIGURE shows that both the separator or the electrode-protective layer 10 and also the cathode 11 comprise an electrolyte 1, 1′ which comprises at least one metal-organic framework and at least one single ion conductor, for example at least one single-ion-conducting polyelectrolyte and/or at least one inorganic single ion conductor. Here, the electrolyte 1 of the separator or the electrode-protective layer 10 and the electrolyte 1′ of the cathode 11 can be either identical or different.

In particular, the separator or the electrode-protective layer 10 can comprise or be formed by an electrolyte 1 which comprises at least one metal-organic framework and/or at least one single ion conductor, for example at least one single-ion-conducting polyelectrolyte and at least one inorganic single ion conductor. The cathode 11 can likewise comprise such an electrolyte 1 or a different electrolyte 1′, for example composed of at least one metal-organic framework and at least one polymer electrolyte, for example polymer gel electrolyte.

The drawing FIGURE shows that the cathode 11 can additionally comprise at least one cathode active material 2 in particulate form and optionally at least one electrically conductive addition 3, in particular for improving the electrical conductivity, for example carbon black and/or graphite, and can in particular be provided with a power outlet lead 4.

The drawing FIGURE shows that, in the embodiment depicted, the anode 12 is a lithium metal anode, in particular composed of metallic lithium. As a difference from the structure shown in the drawing FIGURE, the anode 12 can also have a structure analogous to the cathode 11 and comprise at least one anode active material, for example a lithium intercalation and/or insertion and/or alloying material, and an electrolyte composed of at least one metal-organic framework, for example an aluminum carboxylate, and at least one single ion conductor, for example at least one single-ion-conducting polyelectrolyte and/or at least one inorganic single ion conductor.

1. An electrolyte (1, 1′) for an electrochemical cell and/or battery (100), comprising
at least one metal-organic framework and
at least one single ion conductor.

2. The electrolyte (1, 1′) as claimed in claim 1, wherein the electrolyte (1, 1′) comprises at least one metal-organic framework and at least one single-ion-conducting polyelectrolyte and/or at least one inorganic single ion conductor.

3. The electrolyte (1, 1′) as claimed in claim 1, wherein the electrolyte (1, 1′) comprises at least one metal-organic framework, at least one single-ion-conducting polyelectrolyte and at least one inorganic single ion conductor.

4. The electrolyte (1, 1′) as claimed in claim 1, wherein the at least one metal-organic framework comprises aluminum and/or zinc.

5. The electrolyte (1, 1′) as claimed in claim 1, wherein the at least one metal-organic framework comprises an aluminum carboxylate.

6. The electrolyte (1, 1′) as claimed in claim 1, wherein the electrolyte (1, 1′) further comprises at least one ion-conductive polymer.

7. The electrolyte (1, 1′) as claimed in claim 2, wherein the at least one single-ion-conducting polyelectrolyte comprises at least one unit of the general chemical formula: 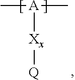
where -[A]- is a unit forming polymer backbones,
X is a spacer and x is the number of spacers X and is 1 or 0, and
Q is a negatively charged group Q⁻ and a counterion Z⁺.

8. The electrolyte (1, 1′) as claimed in claim 7, wherein the negatively charged group Q is a borate anion and/or a perfluoroalkylsulfonylimide anion and/or a sulfonate anion.

9. The electrolyte (1, 1′) as claimed in claim 2, wherein the at least one inorganic single ion conductor comprises at least one lithium argyrodite and/or at least one sulfidic glass.

10. The electrolyte (1, 1′) as claimed in claim 1, wherein the electrolyte (1′) further comprises at least one liquid electrolyte and/or at least one ionic liquid and/or at least one gel-forming solvent.

11. The electrolyte (1, 1′) as claimed in claim 1, wherein the electrolyte (1′) is a catholyte and/or an anolyte.

12. A separator and/or electrode-protective layer (10) for an electrochemical cell and/or battery (100), comprising an electrolyte (1) as claimed in claim 1.

13. The separator and/or electrode-protective layer (10) as claimed in claim 12, wherein the electrolyte (1) comprises from ≥5% by weight to ≤20% by weight of the at least one metal-organic framework.

14. A cathode (11) for an electrochemical cell and/or battery (100), comprising at least one cathode active material (2) and an electrolyte (1, 1′) as claimed in claim 1.

15. An anode for an electrochemical cell and/or battery (100), in comprising at least one anode active material and an electrolyte as claimed in claim 1.

16. An electrochemical cell and/or battery (100) comprising a cathode (11) and an anode (12), wherein a separator and/or an electrode-protective layer (10) is/are arranged between the cathode (11) and the anode (12), and wherein one of the cathode, the anode, and the separator and/or an electrode-protective layer comprises at least one electrolyte (1, 1′) as claimed in claim 1.

17. The cell and/or battery (100) as claimed in claim 16, wherein the one of the cathode, the anode, and the separator and/or an electrode-protective layer is the separator and/or the electrode-protective layer (10).

18. The cell and/or battery (100) as claimed in claim 16, wherein the one of the cathode, the anode, and the separator and/or an electrode-protective layer is the anode (12), the anode also comprising at least one anode active material.

19. The cell and/or battery (100) as claimed in claim 16, wherein the one of the cathode, the anode, and the separator and/or an electrode-protective layer is the cathode (11), the cathode also comprising at least one cathode active material (2).

20. The cell and/or battery (100) as claimed in claim 16, wherein the cathode (11) comprises an electrolyte which comprises at least one metal-organic framework and at least one polymer electrolyte composed of at least one ion-conductive polymer and at least one electrolyte salt.

21. The electrolyte (1, 1′) as claimed in claim 1, wherein the at least one single ion conductor is polymeric and/or inorganic.

22. The electrolyte (1, 1′) as claimed in claim 1, wherein the electrolyte (1, 1′) comprises at least one metal-organic framework and at least one single-ion-conducting polyelectrolyte and/or at least one glass-like and/or ceramic single ion conductor.

23. The electrolyte (1, 1′) as claimed in claim 1, wherein the electrolyte (1, 1′) comprises at least one metal-organic framework, at least one single-ion-conducting polyelectrolyte and at least one glass-like and/or ceramic single ion conductor.

24. The electrolyte (1, 1′) as claimed in claim 7, wherein the negatively charged group Q⁻ is a borate anion and/or a trifluoromethanesulfonylimide anion and/or a sulfonate anion.

25. The electrolyte (1, 1′) as claimed in claim 2, wherein the at least one inorganic single ion conductor comprises at least one lithium argyrodite and/or at least one sulfidic glass.

26. The cell and/or battery (100) as claimed in claim 16, wherein the cathode (11) comprises an electrolyte which comprises at least one metal-organic framework and at least one polymer electrolyte composed of polyethylene oxide and lithium bis(trifluoromethanesulfonyl)imide.
